(19) United States
(12) Patent Application Publication
(10) Pub. No.: US 2005/0248723 A1
(43) Pub. Date: Nov. 10, 2005

(54) Noninvasive retinal image-scene displacement means

(76) Inventor: William L. Mohan, Barrington, IL (US)

Correspondence Address: ROBERT A. BROWN, PO BOX 2127, NORTHBROOK, IL, 60065-2127, US

(21) Appl. No.: 10/679,530

(22) Filed: Oct. 6, 2003

(51) Int. Cl. G02C 7/06

(52) U.S. Cl. 351/170

(57) ABSTRACT

A noninvasive optical device for redirecting incoming light rays comprising a distant image scene being received by a human system prior to impinging on an optical entrance pupil of the human vision system. The device effects a precise repositioning of all incoming light rays of an image scene and provides identical image repositioning to both eyes of the human vision system to ensure binocular accommodation.

### BACKGROUND OF THE INVENTION

Vision corrective means have become a part of man kind way of life for many years. As such, they are referred to as spectacles, or a pair-of-glasses. The more common vision defects are, near-sighted, far-sighted, and binocular accommodation.

The optical corrective means for these vision defects were to have clinically prescribed lenses, suitable for correcting the particular vision optical problem. Such noninvasive optical correcting means were either made of a suitable glass or of a particular, man-made plastic material. Such lenses are mounted in spectacles, clip-ons, or unmounted for use as contact-lens.

For those persons whose vision suffer permanent damage to the retina photo-sensing area and in particular, the macula area of the retina, they have had very little offered by the medical-optical profession in means of a noninvasive vision aid to prolong their seeing capabilities.

The vision-optical problem associated with retinal damage is a Principal Purpose Of This Invention.

### SUMMARY OF THE INVENTION

This invention relates to noninvasive optical means for redirecting all of the incoming light rays comprising a distant image scene prior to those incoming light rays impinging upon a human vision system's optical-entrance pupil.

Said vision system, being binocular, is composed of two, near identical, separate optical systems, known as an eye. Each eyes optical system has a fixed-position lens-pair, whose common optical-axis extends in thru the center of the first lens, the cornea, back thru the center of the pupil, and thru the center of the second lens, back thru the internal-cavity of the eye, and onto the central area of the retina's macula area, known as the Foveola.

The incoming light rays, comprising a total-image scene, are comprised of a myriad of, point-source, ray bundles. These bundles are further composed of parallel-oblique rays and paraxial-rays.

Paraxial rays are those rays that either lie in the same space as the eyes imaginary, optical-axis, or are parallel within a degree, to this axis. All of these rays share a common image-scene point-of-interest at focus, upon passing thru the afore mention lens system. This focal area, centered about the optical axis, is at the central area of the macula, the foveola and constitutes the most acute image sensing area of the retina.

The parallel-oblique ray bundles all share their own, unique, point-of-focus, that constitutes the greater percentage of the replication of the total image scene upon the central retina area.

The image-scene-of-interest, is that particular portion of a larger image scene that a person is, at that immediate moment in time, is intent on. For example; a word you read as you read thru a line of words.

The incoming rays that constitute the image-scene-of-interest are basically paraxial or are clustered within a degree of the optical-axis as parallel-oblique rays.

What directs our eyes to this particular point-of-view is our, subliminal, parasympathetic control system.

It is a primary purpose of this invention to effect a precise repositioning of all incoming light rays that constitute an image scene. More particularly, those rays that lie on and around the lens systems optical axis where in, the retina-macula area is damaged.

It is a further purpose of this invention to provide identical image repositioning to both eyes to insure binocular accommodation.

It is also a purpose of this invention, that such optical means for image repositioning means be provided as spectacles, or as ‘clip-on’, for those persons who have need for other refractive correction means.

These and other considerations will become apparent with the following descriptions.

### DESCRIPTION OF THE DRAWINGS

FIG. 1 is a perspective view of a positive power, single lens system, imaging a bundle of paraxial rays from a distant image scene point, and a bundle of parallel-oblique rays from the same distant image scene, but a different image point.

FIG. 2 is a perspective view of the same single lens as of FIG. 1 with the paraxial rays first passing thru a wedge-prism, these rays then being converted to parallel-oblique rays, prior to being imaged by the lens.

FIG. 3a is a perspective view of a square area wedge-prism, showing a dotted circle of radius R, to be converted to a round, lens-type, wedge-prism.

FIG. 3b is a side view of the FIG. 3a, showing the parameters that determine the wedge-prism optical characteristics.

FIG. 4 is a perspective over-view of the invention.

FIG. 5 is a log.-log. plot of: Visual Acuity vs Image position, angular displacement relative to the Fovea center.

### DESCRIPTION OF THE PREFERRED EMBODIMENT OF THE INVENTION

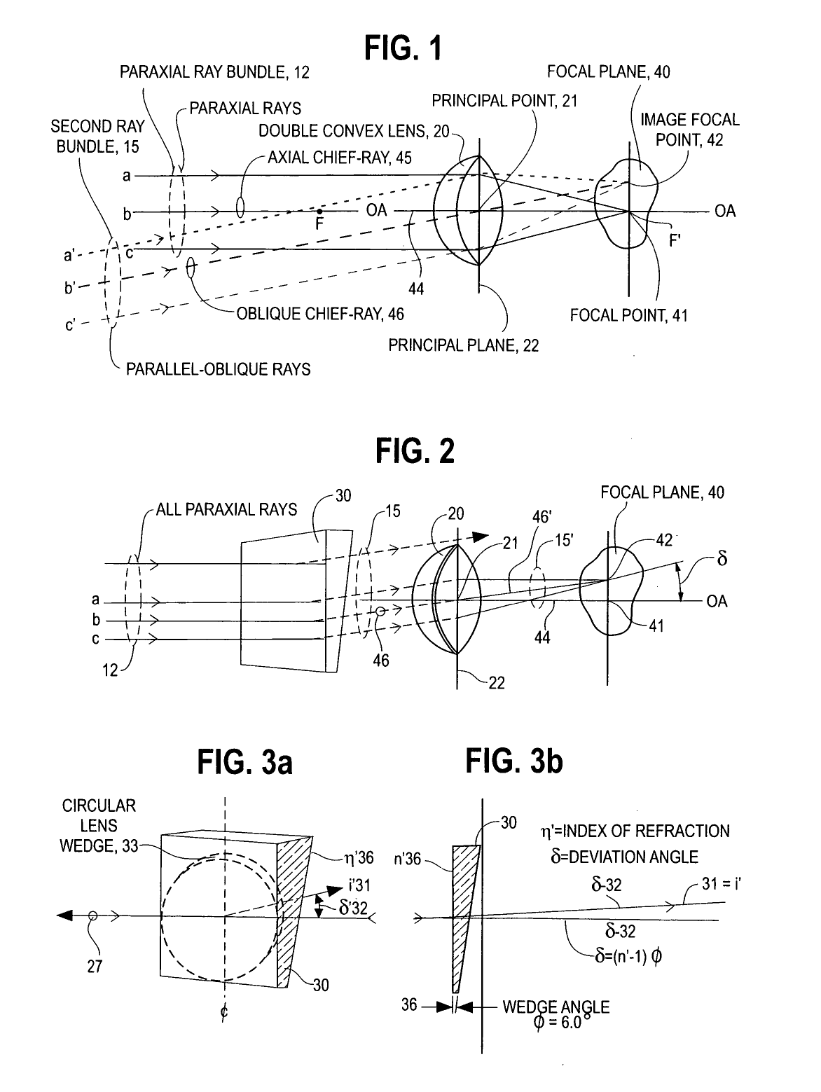

FIG. 1 illustrates the relationship between incoming paraxial ray bundle 12 and double-convex lens 20, having principal-point 21. These incoming rays 12, radiating from a common point of a distant image scene, not shown, are parallel to the optical axis 40 of lens 20. Ray 45 of ray bundle 12 is coaxial to lens 20 optical axis 40, thus passes thru the center of lens 20 and its principal-point 21. Such a ray passes thru the lens system undiviated in its direction. Further, in ray bundle 12, all the rays are parallel to ray 45 and centered in a very small angular displacement about ray 45 in this bundle 12 and about the optical-axis 40, are refracted by lens 20 to a common focal-point 41 along the optical-axis 44. [The dimensional scale of FIGS. 1 and 2 is for clarity in viewing.]

Further illustrated in FIG. 1 is second ray bundle 15, comprised of oblique rays, radiating from an off-axis point source, of the same distant image scene mention above. Oblique chief ray 46 in this ray bundle 15 also passes thru the center of lens 20 principal point 21 undiviated in its direction, thru to image plane 40 to image focal-point 42. All the ray in bundle 15 are parallel to, and centered in a small angular displacement about chief-ray 46, are refracted by lens 20 to a common image focal-point 42. If the only rays in existents were parallel-oblique rays, ray 46 could be considered, ‘on the optical-axis’ and that lens 20 was tilted down by the angle sigma, which is equivalent to the deviation angle of ray 46 FIG. 2, on back focal plane 40.

The above description greatly simplifies the complex replication, by lens 20, of all the incoming object scene rays to an image scene at back-focal plane 40.

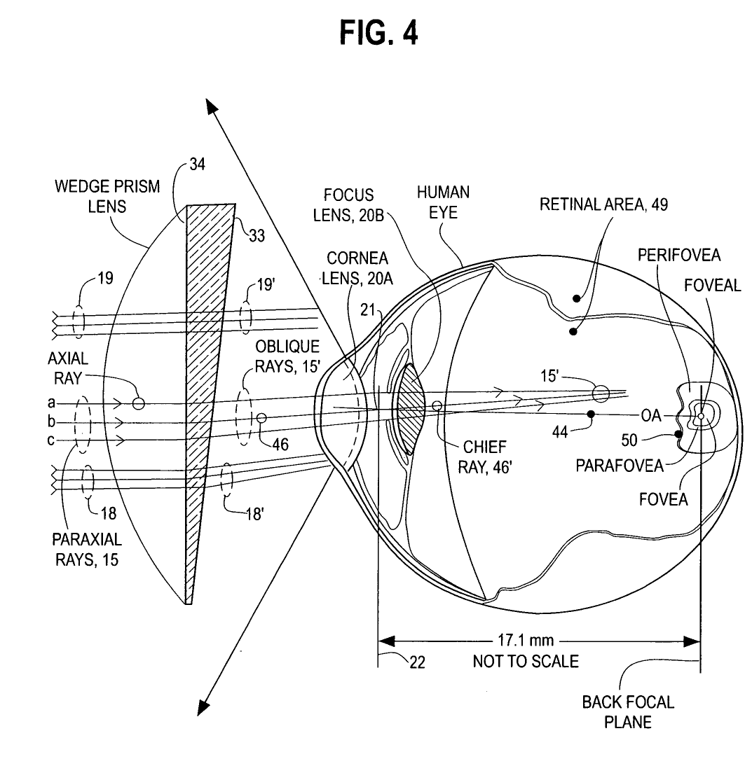

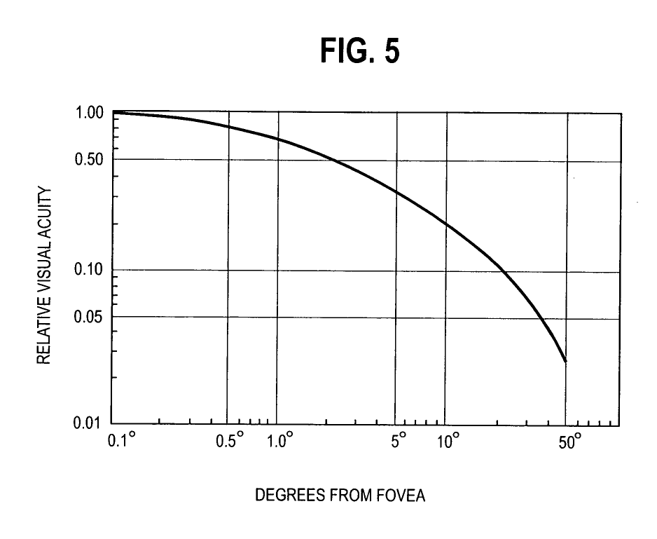

The human eye vision system also has, basically, a simple lens system, 20a and 20b of FIG. 4, along with an extremely complex imag-scene control system, parasympatheticly dominated.

What is of prime consideration, when the vision system sustains damage to the Image sensing area the retina; and in particular, the on-axis, center-macula area of the retina, the foveola; is to circumvent the eyes vision-system loss of paraxial optical sensing along the existing optical axis 44 FIG. 4. To convert all incoming image scene rays, bundles 15-16-19 of FIG. 4, to parallel-oblique rays bundles, 15′-18′-19′. Thus imposing the use of these off-axis rays, as needed for determining our innate, point-to, image scene of interest; To redirect the end-point of the incoming oblique, ray bundle 15′, to a predetermine new position on the macular area of the retina, away from the present damaged area. Thus establishing chief-ray 46, FIG. 4, as the psudo-optical-axis ray, the center of the retinal image scene.

The image-scene-of-interest, discussed in, Summary of the Invention are basically, comprised of paraxial ray bundles, where on-axis, the normal eye vision system is at its highest acuity.

Those persons whom vision loss is due to the slow progression of retina damage by the disease, Glaucoma, usually become aware of its dire effect by a gradual loss of their peripheral vision. As the disease continues, the damage to the retina progresses, like a dark shade closing, such a malignancies continues, until the macular area is damaged and our ability to see clearly is now of utmost concern.

Glaucoma, having no known cure, has various treatments, as prescribed by the ophthalmology profession, to slow-down its time-clock of progressing. Some are invasive means, others are noninvasive means as, prescribed eye-drops.

The above treatments are an absolute requirement. In addition to the need of slowing down the advancement of retina damage, there exist the capability of, noninvasely, moving and recentering the total-incoming retinal image away from the present damaged macular-retina area, to a precise, pre-selectable, of-axis position.

This retinal-image scene manipulation is accomplished by means of a, specifically prescribed, optical wedge-prism 33 FIG. 4.

The wedge-prism 30 FIG. 3 is a simple optical device that has had many optical applications. Optical wedge-prisms are used in numerous image-scanning devices and also Ophthalmologists clinical eye testing device. This device, the Risley-Herschel Prism, utilizes a pair of identical round wedge-prism where one wedge-prism is rotated in respect to the other, to give the equivalent of having a single-variable power and variable direction of the deviation of the wedge-prism combo. The use of such a device is in eye testing for binocular-accommodation.

FIG. 3a and FIG. 3b mechanical geometry, along with the index-of-refraction [n′] 36 FIG. 3, determine the optical characteristics of wedge prism 33 FIG. 3 and FIG. 4. The angle of deviation of a refracted ray is, sigma, 32 FIG. 3 The direction of the refaction is shown as line vector [i′] 31 FIG. 3a. This vector 31 is determined by the geometry of the wedge-prism and its physical rotation, normal to object image scene input to the wedge-prism 33 FIG. 3a. Prism power is measured in diopters, one diopters is a ray angular displacement of one centimeter per meter of travel, in air.

The complete control of the optical centering of the retinal-image, as specified by clinical and historical medical data can prolong the vision capabilities of those who suffer partial vision loss due to permanent damage of the central sensing area of the retina.

While the present invention has been described with reference to the above preferred embodiments, it will be understood by those skilled in the art, that various changes may be made and equivalence may be substituted for elements thereof without departing from the scope of the present invention. In addition, modifications may be made to adapt a particular situation or material to the teachings of the present invention without departing from the scope of the present invention. Therefore, it is intended that the invention not be limited to the particular embodiments disclosed in carrying out this invention, but that the present invention includes all embodiments falling within the scope of the appended claims.

1. A vision correcting optical device for redirecting incoming image scene light rays from a person's damaged central macular retina area identified as the fovea to a predetermined non-damaged macular retinal area identified as the perifoveal area comprising
a wedge-prism lens for receiving coaxial parallel light rays for converting said light rays to parallel oblique rays prior to passing through a lens of a human eye and registering an image of said rays on the retina,
whereby said wedge-prism lens is effective to redirect light rays through said human eye lens to a predetermined focused position on a non-damaged macular retinal area.

2. An optical device as claimed in claim 1 wherein said wedge prism lens comprises a pair of identical wedge-prism lens, one lens for each eye, each said lens adaptable to be oriented in rotation relative to each other so as to provide identical image repositioning to each eye and thereby achieve binocular accommodation such that each eye is focused on the same point of interest.

3. An optical device as claimed in claim 2 wherein each said wedge prism lens is adaptable to compound and supplement correction of an existing pair of image corrective optics.

4. An optical device as claimed in claim 1 wherein each said wedge prism lens is adaptable to be installed in spectacle frames and worn by persons who require corrective repositioning of light rays.

5. An optical device as claimed in claim 2 wherein each said wedge prism lens is adaptable to be installed in spectacle frames that may be attached to glasses worn by persons who require other refractive vision correction.

6. A method of making a vision correcting optical device for redirecting incoming image scene light rays from a person's damaged central macular retina area identified as the fovea to a predetermined non-damaged macular retinal area identified as the perifoveal are comprising the steps of
providing a first wedge-prism lens for a human eye,
providing a second wedge-prism lens for the other human eye,
rotating one of said wedge-prism lenses in an oriented relationship to the other of said wedge-prism lenses to convert said light rays to parallel oblique rays prior to passing through the lens of each said human eye, and
providing identical image repositioning to each eye to achieve binocular accommodation such that each eye is focused on the same point of interest.
